(19) United States
(12) Patent Application Publication
(10) Pub. No.: US 2017/0280210 A1
(43) Pub. Date: Sep. 28, 2017

(54) CONNECTED CLIMATIC SYSTEM

(71) Applicant: MULLER ET COMPAGNIE, PARIS (FR)

(72) Inventors: JEAN-LOUIS MORARD, PARIS (FR); FRANÇOIS POURRAT, PARIS (FR)

(21) Appl. No.: 15/514,491

(22) PCT Filed: Sep. 25, 2015
(86) PCT No.: PCT/EP2015/072155

§ 371 Date: Mar. 24, 2017

(30) Foreign Application Priority Data
Sep. 25, 2014 (FR) 1459095

(51) Int. Cl. H04Q 9/00; G08C 17/02; H04W 4/00; H04W 4/02

(52) U.S. Cl. CPC H04Q 9/00; H04W 4/023; G08C 17/02; H04W 4/005; G08C 2201/42; G08C 2201/51; H04W 84/18

(57) ABSTRACT

A climatic system includes a climatic apparatus and a local network, in particular wireless. A computer is linked to an internet network access router. The climatic apparatus includes a communicating device to transmit on the local network an item of information relating to its manner of operation. A method for implementing such a climatic system is also provided.

The invention relates to a connected climate system. The invention equally concerns climate engineering, decisional computing and inferential computing, commonly qualified by the term “Big Data”, for the purpose of determining and predicting behaviors from a mass of data, in order to optimize the operation of a system or to analyze its environment.

The term “climate system” denotes the set of the devices and their methods of implementation that make it possible, at the price of energy consumption, to locally modify a climate ambience, more particularly, but not exclusively, the temperature and the relative humidity. Non-exhaustively, the devices involved in a climate system comprise the heating devices, based on radiation or covection, the reversible or non-reversible air conditioning devices, the controlled ventilation devices and the sanitary hot water production means.

In all industrialized countries, the energy consumption of the climate systems represents the greatest share of the final energy consumption, generally in the region of close to 40% of the total energy consumption of the country.

Many devices involved in a climate system are devices consuming electrical energy and which, generally, transform this electrical energy into heat, either by direct heating of the medium as in the case of an electrical convector, of a radiant panel or of a water heater or even by a transfer of heat, as in the case of a heat pump or an air conditioning device.

These climate apparatuses, notably electrical, are capable of storing energy by using the thermal inertia of the medium or by using accumulation means internal to the climate apparatus, for example, by using the change of phase of a substance, and said climate apparatuses are capable of restoring, according to certain embodiments, the duly stored energy. Thus, such climate apparatuses constitute energy consumption smoothing means that are particularly useful in management for regulating the production and the consumption of a non-storable energy, such as electrical energy, and more particularly in the context of renewable energies such as wind or photovoltaic energies.

According to a first model mostly used currently to smooth the consumptions, the energy operator puts in place advantageous tariff bands and penalizing tariff bands, even load-shedding provisions, to counter the natural consumption trends of the consumers and smooth their energy consumption. The recent climate apparatuses, such as electrical radiators, comprise means that make it possible to optimize their operation to preserve the comfort of the user and the energy consumption thereof, in the presence of load shedding or cut-off tariffs.

In parallel, the energy operator uses different energy storage technologies, primarily based on water pumping, gas compression or storage batteries. These technologies store electrical energy in another form of potential energy, mechanical or chemical, which must be transformed back into electrical energy before being able to be reinjected onto the network. These regulation modes are driven according to macroscopic energy consumptions, which are planned on the basis of data that are also macroscopic such as meteorology and population behaviors, and by a market system for purchasing and selling energy between the operators interconnected by the network. This model is perfectly suitable for mass rather than random energy production, by hydroelectric, thermal or nuclear power stations. However, with the proliferation of renewable energy sources, influenced by phenomena on a local scale, such as wind farms, photovoltaic units or microgeneration, whose instantaneous production potential cannot be determined, this type of model is potentially taken by default and leads, in some cases, to negative energy selling prices and to very significant fluctuations of this selling price over periods which are unrelated to the responsiveness of the regulation system.

The storage and the regulation of the energy consumption on the consumption terminal scale offers solutions to this problem. Thus, load-shedding electrical heating or an air conditioning apparatus for a few seconds or a few minutes has no perceptible consequence for the end user. However, when this load shedding is performed over a large number of apparatuses, the drop in consumption is sufficient to contribute to a consumption peak cut-off or to the purchase of energy in a low-cost production period and the resale thereof in a higher-cost production period. Similarly, the storage of the electrical energy in thermal form in a climate apparatus makes it possible to directly restore this thermal energy without involving the reinjection of electrical energy into the network. This regulation mode is feasible on a regional, state, village or district scale. However, the models of consumption on this much finer scale must take into account influencing factors that are more complex to predict than the macroscopic behavior of populations. Thus, anticipating the behaviors and the energy consumption requires a household-scale approach.

The document US 2011/046792 describes a climate system comprising one or more thermostats connected to a local area network, said local area network comprising a computer connected to the Internet.

The invention aims to resolve this problem of the prior art and, to this end, relates to a climate system comprising:

a. a climate apparatus;

b. a local area network, notably wireless, comprising a computer linked to an Internet network access means;

c. the climate apparatus comprising means, called communicating means, capable of emitting, over said local area network, an information item relating to the operation of said climate apparatus;

d. a personal terminal;

climate system in which the communicating means of the climate apparatus are capable of dialoging with the personal terminal and of relaying the signals from the personal terminal over the local area network.

Thus, the climate system that is the subject of the invention makes it possible to collect data on the operating conditions of the climate apparatuses of a location corresponding to the extent of the local area network, that is to say, more commonly, a household, even to discriminate an information item or a behavior relating to each room of the household in which a climate apparatus is installed and to transmit information drawn from these data via Internet to an energy consumption regulation service or any other service. The system that is the subject of the invention does not require the climate apparatuses to have a static IP address and the emission means are adaptable to an existing installation benefitting from the electrical power supply thereof. The nature of the data transmitted via Internet is determined by the computer. Thus, the climate apparatus of the system that is the subject of the invention is capable of relaying the information from a personal terminal, such as a cell phone, or even of emitting information to this terminal in order to inform the owner of said terminal as to the mode of operation of the system, and, more generally, to interact with the owner of said terminal while the communicating means make it possible to have the system driven by said personal terminal. Thus, the system that is the subject of the invention exploits, on the one hand, the presence in virtually all the rooms of a dwelling of a climate apparatus to relay the signals from the personal terminal and dialog therewith. Since the computer of the local area network is linked to the Internet, the functions of the system are shared between the climate apparatus and its own driving and automation means, the local computer, a user authority connected to the computer via Internet and possibly the personal terminal. Thus, these functions are open-ended and can be adapted to different needs. Thus, the climate apparatuses of the climate system that is the subject of the invention, in addition to their primary climate function, constitute relays between the user, provided with his or her personal terminal, and a much more vast system, via the Internet network, the functions being distributed between these three systems.

The term computer is used here in a broad sense and it concerns a device comprising a processor, input and output ports and interfaces with the local area network and the Internet network access means, as well as memory means.

The invention is advantageously implemented according to the embodiments described hereinbelow, which should be considered individually and in any theoretically feasible combination.

Advantageously, the climate apparatus comprises a sensor for measuring a parameter relating to the environment of said apparatus and the communicating means of said apparatus are capable of emitting an information item relating to the measurand estimated by said sensor. Thus, the system that is the subject of the invention uses, as medium, the climate apparatuses installed in almost all the rooms of particular premises to sense elements relating to the climate environment or, more generally, to the ambience in these particular premises. Such information makes it possible to obtain a fine image of the use of said premises.

Advantageously, the climate apparatus comprises presence detection means and the communicating means of said apparatus are capable of emitting an information item relating to the state of said detection means. As previously, the system that is the subject of the invention uses the climate apparatuses present in particular premises as medium for handling the detection of the occupancy of parts of these premises. These data can advantageously be used to refine the conditions of occupancy of said premises but also for safety purposes for example.

According to an advantageous embodiment, the communicating means of the system that is the subject of the invention are capable of receiving information from the local area network. Thus, the system that is the subject of the invention makes it possible to collect locally, that is to say in proximity to the climate apparatuses, complex information from connected terminals and adjust the setting thereof based on this information or use this information to refine the analysis of the consumption.

According to a particular embodiment of the system that is the subject of the invention, the climate apparatus comprises:

e. means for driving the operation thereof, capable of exchanging information with the computer.

Thus, the climate apparatus is capable of partly or wholly driving its operation, of driving or analyzing the operation of another climate apparatus, connected to the network, of interacting directly with the personal terminal or even of interpreting a situation deriving from the sensors that it supports and of emitting an information item over the network according to this situation.

Advantageously, the computer of the system that is the subject of the invention comprises, in memory, a climate apparatus location information item.

Thus, the system takes this location into account in the management of the different functions.

According to an advantageous embodiment of the system that is the subject of the invention, the computer is incorporated in the climate apparatus. Thus, the incorporation of such a climate apparatus in particular premises makes it possible to make the climate system of said premises communicating, the communication between the apparatuses of said climate system being handled according to means known from the prior art, for example by a pilot wire or by signals conveyed by the electrical power supply network.

Advantageously, the climate system that is the subject of the invention according to this latter embodiment comprises a plurality of climate apparatuses comprising a housing for the connection of a driving cassette, one of the apparatuses of the plurality comprising a driving cassette capable of performing the functions of the computer and the other apparatuses of the plurality comprising a cassette capable of performing the functions of the communicating means. Thus, each apparatus of the plurality can be configured to make said system communicating. This embodiment makes it possible to upgrade the climate system that is the subject of the invention from an autonomous mode of operation to a communicating mode of operation.

The invention also relates to a method for collecting and transmitting energy data implementing a climate system according to the invention and a recipient, called user authority, which method comprises the steps consisting in:

i. obtaining, via the local area network, a datum on the operation of the climate apparatus;

ii. storing said datum in memory on the computer;

iii. combining the stored data in order to define an energy consumption profile;

iv. transmitting said profile over the Internet to the user authority;

v. emitting, from the user authority, a request triggering the steps iii) and iv), said request comprising information on the data combination mode of the step iii) used to define the profile transmitted in the step iv).

Thus, the method that is the subject of the invention exploits information from the system that is the subject of the invention to establish a profile of behavior of the end consumer. This profile is advantageously used by the user authority, in particular, but not exclusively, to establish a model and forecast of the energy consumption. More particularly, the behavioral profile information of the user of the climate system that is the subject of the invention is transmitted to the user authority at the moment when the latter needs it, which makes it possible to obtain a fine image of the behavior of said user.

Advantageously, the request emitted in the step v) comprises information on the data combination mode of the step iii) used to define the profile transmitted in the step iv). Thus, the information transmitted by the computer to the user authority is directly matched to the use targeted by said user authority.

According to a particular mode of implementation, the step i) comprises the steps consisting in:
making a plurality of modifications to the operation of the climate apparatus;
measuring the trend of the climate parameter modified in these modifications to the operation of the apparatus;
computing the modification time constant of the climate parameter driven by the climate apparatus.

Thus, the measurement means of the climate apparatus of the system that is the subject of the invention are advantageously used to obtain information on the environment of the apparatus and the response of this environment, in order to incorporate this information in the driving of said system.

The invention relates also to a method for implementing a system that is the subject of the invention according to an embodiment comprising a personal terminal connected to the network, which method can advantageously be combined with the preceding method according to any one of its embodiments and which comprises the steps consisting in:

u. obtaining the identifier of the personal terminal;

v. obtaining information on the user of the personal terminal;

w. detecting the proximity of the personal terminal with the climate apparatus of the system;

x. transmitting the detection information over the personal network;

y. modifying the operation of the climate apparatus as a function of the information received in the step v).

Thus, this implementation of the system that is the subject of the invention is capable of detecting the presence and the position of a person, or more generally a holder of a personal terminal. This information can be used for the driving of the system that is the subject of the invention or to establish a consumption profile, and, more particularly, the operation of the climate apparatus and of the system that is the subject of the invention are modified as a function of the profile of the user.

According to a particular embodiment of this method, the latter comprises, between the steps w) and x), a step consisting in:

z. obtaining the geolocation of the personal terminal and using this information item to geolocate the climate apparatus.

Thus, the geolocation capabilities of the personal terminal are advantageously used to locate the climate apparatus and this location is used to optimize the operation of the climate system that is the subject of the invention.

Since the system that is the subject of the invention is capable of dialoging, via the computer, with a user authority, said authority is able to propose services based on the information exchanged and to extend the usefulness of the climate system beyond its primary heating or air-conditioning use.

Thus, according to one example of use, a system that is the subject of the invention whose climate apparatus comprises a sensor capable of evaluating a parameter relating to the quality of the air is used to monitor and adjust the quality of the air of particular premises.

According to another example, the sensor is capable of detecting a presence, and the system that is the subject of the invention is used to detect an intrusion into particular premises.

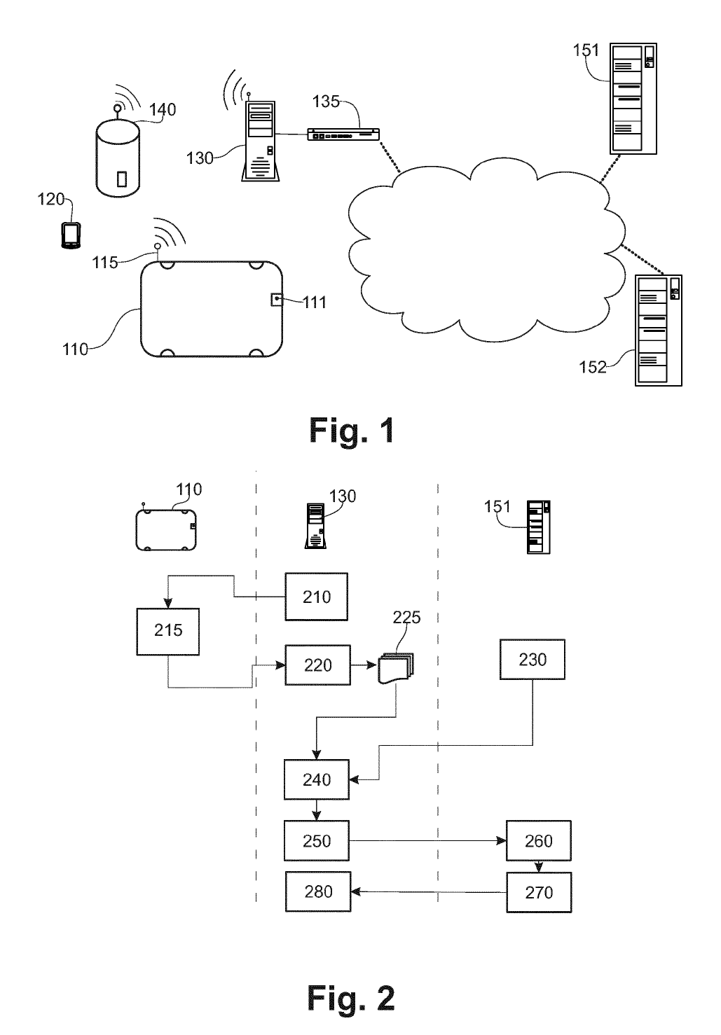

The invention is explained hereinbelow according to its preferred and nonlimiting embodiments, and with reference to FIGS. 1 to 4 in which:

FIG. 1 illustrates, by a schematic illustration, an example of an embodiment of the climate system that is the subject of the invention;

FIG. 2 is a flow diagram of an example of a method for implementing the climate system that is the subject of the invention;

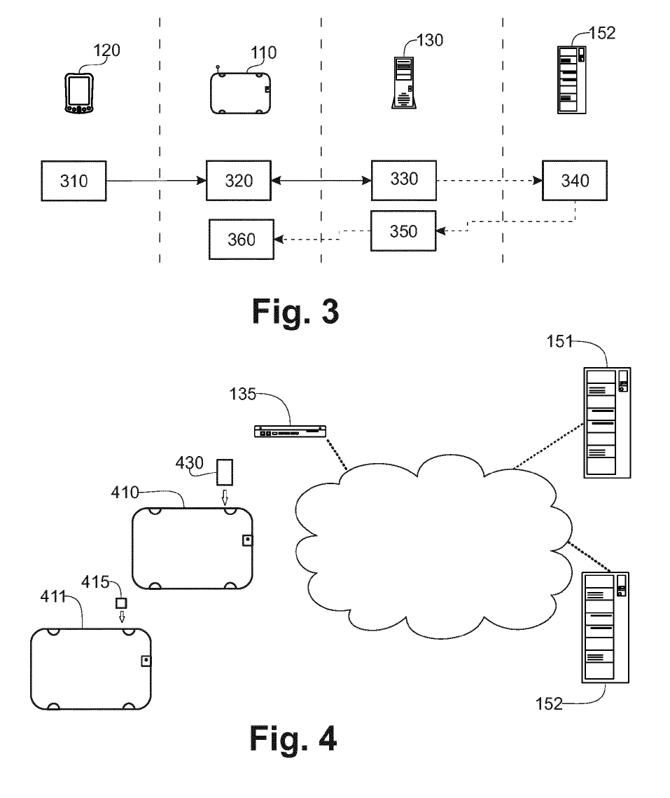

FIG. 3 is a flow diagram of another example of a method for implementing the climate system that is the subject of the invention; and

FIG. 4 illustrates an example of an embodiment of the system that is the subject of the invention in which the computer is incorporated in one of the climate apparatuses.

In FIG. 1, according to an example of embodiment, the system that is the subject of the invention comprises a climate apparatus (110, 140). According to this particular example, said apparatus is an electric radiator (110) or a water heater (140). Alternatively, or additionally, the system that is the subject of the invention comprises a climate apparatus such as a reversible or non-reversible air conditioning, single-or dual-flow controlled mechanical ventilation or a fuel-burning stove or a co-generation boiler without this list being exhaustive. Generally, several types of climate apparatus are present in the system that is the subject of the invention. According to this example of embodiment, said electric radiator comprises a temperature probe (not represented) driving a thermostat, and an additional sensor (111), for example a presence sensor, a relative humidity sensor, a carbon dioxide (CO₂) sensor, a motion detector or even a smoke detector. The climate apparatus is connected to the electrical network and comprises means (115) for connection to a computer (130) by a local area network, notably wireless, of WLAN type or a personal area network of WPAN type. According to one example of embodiment, this link to the network is produced by a transceiver according to the WiFi® protocol, the connection means being powered by the electrical power supply of the apparatus. According to other embodiments, the local area network is a wired network, for example using bearer currents on the electrical distribution network of the building or even a KNX® bus.

Additionally, the climate apparatus comprises means (not represented) for connection to a personal area network, for example in the form of an emitter according to the ZIGBEE®, KNX® or BLUETOOTH® standards. Thus, according to this example of embodiment, the climate apparatus is capable of being connected, via this personal area network, to a personal terminal (120) allowing this type of connection, for example a cell phone or a PC tablet. Thus, the climate apparatus is capable of relaying, over the local area network, the information exchanged with said personal terminal (120). According to another embodiment, the personal terminal is a badge comprising an electronic radiofrequency tag and the climate apparatus (110) comprises means for reading said tag when the latter is in proximity to said apparatus. A computer (130) is connected to the local area network and to the Internet, for example via a router (135). Alternatively, the router (135) and the computer are the same apparatus. The connection by Internet is thus produced by a wired network, by a cell phone network or even via a specific cellular network for connected objects of SIGFOX® type.

Thus, the climate apparatuses (110, 140) of the system that is the subject of the invention are visible only in the local area network, and only the computer has an IP address in the Internet network. All of this system is installed in a same household or a same building. Said computer (130) is capable of addressing data and of dialoging via the Internet network with one or more servers (151, 152) called “user authorities”. Said user authorities (151, 152) use the formatted and computed data which are transmitted to them by the computer (130). These data make it possible to establish a profile of the household or of the building equipped with the system that is the subject of the invention, and, according to the information collected, a profile of the occupants of the household or of the users of the building.

According to one embodiment, the computer of the local area network accesses information from a home-automation component other than a climate apparatus, for example a switch, a rolling blind control, a smoke detector or even an anemometer, said component being directly connected to said local area network, for example by means of the KNX bus, or else this home-automation component is connected to said local area network via a so-called personal area network established with the climate apparatus.

According to a simple example of embodiment, the climate apparatus is an electric convector comprising an electrical resistor, a thermostat and means for controlling the power supply cycles of said resistor according to the setting of the thermostat. This type of equipment is widely used in a large number of households. The system that is the subject of the invention can be adapted to an existing installation, by equipping such a climate apparatus with an emission module (115) capable of broadcasting over the network the instants during which the resistor of the apparatus is electrically powered and the instants during which said resistor is not powered. The computer (130) easily computes, from these data and from the power of the apparatus stored in its memory, the energy used for the heating and the time bands during which this energy is dissipated. These data, sent to the user authority (151, 152), make it possible, when they are associated with other data, for example the outdoor temperature at the location of the household, to determine, in heating periods, the occupancy of the household and thus, for example, to differentiate a secondary residence from a main residence, or else to classify the household according to its real energy efficiency.

Most climatic apparatuses also comprise sensors and sophisticated driving means, making it possible to adapt the operating conditions of the apparatus according to its environment or the practices of the user. Thus, most of the electric radiators comprise a temperature probe for the closed-loop regulation of their operation as a function of a targeted temperature. As an example, the document FR 2 982 346 describes a climate apparatus, capable of adapting its operating conditions according to the actual use of the dwelling room in which it is installed, and which comprises:
a presence, noise and vibration detector;
environmental sensors such as sensors of relative humidity or carbon dioxide level, the presence of pollutants or a brightness sensor;
a window or door opening detector.

The transmission of this information to the computer and the processing thereof according to an appropriate model make it possible to create a profile of the dwelling equipped with such a system and of its occupants. The accuracy of the profile thus obtained allows the user authority (151, 152), by means of an appropriate model, to anticipate the energy consumption of the household, if necessary room by room, and to implement a diffuse storage of electrical energy in the form of heat. The climate apparatus (110) is not connected directly to said user authority, only the computer (130) is connected to the Internet. Thus, the nature, the frequency and the quantity of the information transmitted to the user authority are determined by this computer, which comprises the firewall and the security functions necessary to protect the private life of the users.

In FIG. 2, according to an example of embodiment of the method for implementing the system that is the subject of the invention, during an interrogation step (210), the computer, via the local area network, interrogates the climate apparatus (110) or apparatuses connected to the local area network to obtain data. On reception of the request, according to an emission step (215), the climate apparatus (110) emits information over the local area network to the computer (130). As is described above, this transmitted information consists of information on the operation of the apparatus, but also information delivered by the sensors of the climate apparatus or even information resulting from a preprocessing performed by the programing and driving means of said climate apparatus (110). Each climate apparatus is identified on the local area network, for example, by means of the MAC address, or physical address, of its emitter. When the emitter does not have a MAC address, the climate apparatus is identified on the network by an initial dialog protocol with the computer. Thus, the computer is able to identify the source of these data and advantageously comprises in memory the characteristics of the apparatus, such as its nature: radiator, water heater, air-conditioner etc., its power, its position in the building and any useful parameter. According to a storage step (220), the computer sorts the data thus received, notably as a function of the date and time of reception, and stores them in a memory (225). During a request step (230) the user authority (151) addresses a request to the computer (130). According to an example of embodiment, said request comprises both a data transmission request and a protocol for processing these data before transmission. The user authority (151) and the computer (130) are linked by Internet and the computer (130) has an IP address. On reception of this request, during a processing step (240), the computer (130) collects the data stored in memory (225) and applies to them the processing protocol which has been transmitted to it by the user authority (151). According to a response step (250), the computer (130) transmits by Internet the result of the processing applied and the requisite data to the user authority (151) which recovers them during a reception step (260).

According to an example of embodiment of the system that is the subject of the invention, the computer (130) is capable of driving the climate apparatus (110). Either by directly addressing, via the local area network, an instruction to said climate apparatus, or by addressing an instruction to a driving means capable of addressing a command to the climate apparatus, for example via a pilot wire, or by signals conveyed by the electrical power supply network.

Thus, according to this embodiment of the system that is the subject of the invention, during an analysis step (270), the user authority (151) analyzes the data transmitted by the computer (130) and more generally by the climate systems which are connected to it and emits, by Internet, an instruction to the computer (130). On reception of this instruction, the computer (130) emits (280) an operating command to the climate apparatus (110) or the climate apparatuses forming the climate system of which this computer forms part. This mode of implementation of the method and of the device that are subjects of the invention allows the user authority to address more complex consumption instructions than a simple cut-off. For example, such an instruction consists in limiting the heating or air-conditioning power of the household to a defined threshold for a defined duration. The management of the climate apparatuses of the system to achieve this is performed by the computer (130), and not by the user authority, a computer which, according to the embodiment of the climate system that is the subject of the invention, performs this management by dialog with individual programming and driving means of the climate apparatuses.

The exchange protocols between the user authority and the computer are described in a simplified manner here but comprise, in accordance with the prior art, all the appropriate identification and authentication steps.

The exchanges between the user authority and the system that is the subject of the invention are not limited to a use targeting the smoothing of the energy consumption. Thus, the profiles transmitted can be used for commercial and advertising purposes by the user authority. In effect, more particularly when the climate apparatuses of the system that is the subject of the invention are provided with sophisticated means and sensors, the method that is the subject of the invention makes it possible to create a profile of the users of the system outside of their Internet or social network connection times and thus, for example, to target promotional operations. This is all the more advantageous when the climate apparatuses are present in virtually all the rooms of the building, when it is possible to easily deploy the system that is the subject of the invention over any existing climate installation, by the incorporation of emission modules on the climate apparatuses, when the system is able to transmit data continuously and when the users of the system derive benefits from its installation, notably in terms of energy saving and comfort. To this end, the computer of the system that is the subject of the invention is connected by Internet to several user authorities capable of providing different services and exploiting a variety of information. Said services include the safety of goods and persons, health or optimization of comfort without this list being exhaustive.

According to another aspect of the system that is the subject of the invention, the latter is capable of accepting the connection of a personal terminal. According to an example of embodiment, the climate apparatus comprises means for connection to the local area network comprising the computer, for example a transceiver according to the WiFi® protocol, or even by wire, notably by bearer current using the electrical power supply network powering the climate apparatus. Said climate apparatus also comprises proximity connection means, for example using the BLUETOOTH® protocol, ZIGBEE® protocol, by infrared or even by an antenna capable of detecting a radiofrequency tag of RFID type. Thus, when a personal terminal, like a cell phone or a badge equipped with an electronic identification tag is located in proximity to the climate apparatus and the user of said terminal has authorized the connection thereof, the climate apparatus is capable of detecting the presence of this apparatus, of exchanging information with said apparatus and of relaying this information over the local area network.

In FIG. 3, according to an example of implementation of this embodiment of the climate system that is the subject of the invention, during a connection step (310), the personal terminal (120) located in proximity to the climate apparatus (110) connects to said apparatus. The personal terminal (120) has an identifier which is thus communicated to the climate apparatus. On reception of this connection, the climate apparatus (110) transmits (320) over the local area network the connection information and the identifier of the personal terminal to the computer (130). According to a first variant embodiment, the identifier of said personal terminal is stored in the computer (130) and is associated with preferences of the user stored in the memory of said computer. As a nonlimiting example, these preferences relate to ambient temperatures according to the room occupied by the user (office, lounge, bedroom) and according to the time of day. On reception of the identifier of the personal terminal (120) and through the knowledge of the climate apparatus (110) in the proximity of which said terminal is located, the computer (130) processes this information and addresses to the climate apparatus an operating set matched to these preferences. According to a second variant embodiment, the user owning the personal terminal (120) has subscribed, as user, to a specific service with the user authority (152). The owner of the dwelling, for example a hotel, in which the climate system that is the subject of the invention is installed is also a subscriber to this service as provider with said user authority (152). Thus, according to this variant implementation, in the information processing step (330), the computer (130) addresses, by Internet, to the user authority the personal terminal presence detection information. On reception of this information, the user authority communicates (340) to the computer (130) the preferences of the user. On reception of these preferences, the computer processes them (350) and translates them into settings according to the technical specifics of the climate system before transmitting them to the climate apparatus (110), which adjusts (360) its operation according to the setting. This mode of implementation allows a user subscribing to the service offered by the user authority to restore a similar climatic ambience in all the places that are also subscribers to said service.

The capacity to detect the proximity of the climate apparatus and of a personal terminal is advantageously used in combination with other sensors of the climate apparatus, like a presence sensor, to ensure the monitoring of an elderly or an infirm person by notably exploiting the fact that the climate apparatuses are distributed in all the rooms of a dwelling and that their position in these rooms generally offers them a significant visibility. According to an example of embodiment, the person wears a badge equipped with a radiofrequency tag. The information on detection of the tag by the climate apparatuses, associated with other information, like that from motion sensors, window-opening, temperature or sanitary hot water production sensors, is addressed to the computer and combined to detect a suspect or risky behavior. For example, in a heatwave period, the absence of window opening, a high temperature, a fixed position of the badge in the dwelling and the absence of motion detection in several rooms of the dwelling are likely to generate an alarm transmitted over the Internet to a user authority, which consequently intervenes.

The detection of proximity of the personal terminal or the information delivered by the presence sensor, or even a combination of both are advantageously used to detect the periods of unoccupancy of the premises in which the climate apparatus is installed, notably by learning. To this end, and by way of example, the information delivered by the presence sensor and the personal terminal proximity detection sensor are stored and time-stamped in the memory of the computer. The information acquired over a defined time period is analyzed from a statistical point of view to determine the periods of occupancy and unoccupancy of the premises. The statistical models that make it possible to analyze these data are loaded from the Internet or the data are exported to the user authority which processes said data and communicates to the computer the result of this processing in the form of occupancy or unoccupancy time bands. Advantageously, when the climate apparatus is provided therewith, the information from relative humidity and CO₂ sensors are also used for this purpose.

According to another example of implementation, the system that is the subject of the invention is capable of ensuring the management of the quality of the air of a building. For example, controlling the relative humidity in the air in a dwelling or a building comprising several floors is complex and is often reflected by a build-up of humidity in the upper floors in heating periods and in the lower floors in summer. The combination of these data from the sensors of the climate apparatuses of the system that is the subject of the invention allows the computer to adapt the operation of the heating and of the mechanical ventilation, for example, so as to limit these phenomena. Furthermore, the connection of the computer to a user authority makes it possible to recover meteorological information and to regulate the operation of the system accordingly.

According to another example of implementation, the system that is the subject of the invention allows its user, by subscription to a user authority, to manage his or her periods of absence. Thus, according to an example of implementation, the water heater is progressively cut off at the start of an absence period and progressively returned to operation before the end of the absence period, the dwelling is kept frost-free and progressively returned to temperature before the return of the occupants. In the case where the climate apparatuses of the system with which the dwelling is equipped are provided with presence or motion sensors, the system also makes it possible to detect an intrusion into the premises in a period of absence of the users. This intrusion detection complements a conventional alarm system. The presence of climate apparatuses in many rooms and their capacity to measure a plurality of parameters of the environment allows them to detect suspect situations, notably to detect a window or door opening by a variation of temperature and to detect a presence in the room. In such a suspect situation, the computer of the climate system, according to the examples of implementation, dialogs directly, via a home-automation bus, with the existing alarm system or itself triggers an alarm, for example by addressing an abnormal activity detection message to the user authority.

According to a similar principle, the climate system that is the subject of the invention uses the environment sensors and, more generally, the dialog capabilities of the climate apparatuses of the system to detect and generate technical alerts, alone or in cooperation with other security systems, such as a fire alert, a gas leak, a water leak or even an electricity outage, without these examples being exhaustive.

In FIG. 4, according to a particular embodiment of the system that is the subject of the invention, said system comprises a plurality (410, 411) of climate apparatuses. Said climate apparatuses are provided with a housing capable of receiving a cassette (415, 430) called driving cassette. According to an example of embodiment, said driving cassette comprises electronic modules for driving the apparatus alone and autonomous operation thereof. According to another embodiment, the driving cassette (415) comprises electronic modules for the operation of the apparatus in a network of climate apparatuses and for the exchange of information between these apparatuses. For example, said driving cassette (415) comprises electronic modules, for example in the form of programmable logic circuits, for driving the apparatus (411) in which it is inserted, and electronic modules for emitting and receiving information to and from the other climate apparatuses, over a wired network or over a wireless network. Such a climate system is capable of operating in a coordinated manner between the different constituent apparatuses. Advantageously, one of the apparatuses (410) of said climate system comprises a driving cassette (430) comprising a computer capable of connecting to the Internet. Thus, the insertion of this type of cassette in one of the climate apparatuses of the climate system according to this embodiment makes it possible to make this climate system a communicating system.

According to another example of implementation of the device that is the subject of the invention, information on the location of the climate apparatuses in the premises where they are used is given to the computer. According to examples of embodiment, said location consists of a simple information item relating to the nature of the room in which the climate apparatus is installed, for example: “bedroom”, “living room”, “kitchen”, “bathroom”, possibly associated with the volume or the surface area of said room. Such information is entered to the memory of the computer either by means of the personal terminal or directly into the computer, for example at the time of installation of said climate system. According to a complementary or alternative mode of implementation, such information is associated with a positioning of the climate apparatus on a plan of the premises. This positioning is done, for example, by marking on said plan by the user or the installer. According to yet another embodiment, alternative to or complementing the preceding ones, the climate apparatus is geolocated. According to an example of embodiment, said geolocation is obtained via the personal terminal when the latter is provided with geolocation means such as GPS, or even, via nearby WIFI® terminals. Thus, in the most comprehensive case, the computer has, for each climate apparatus of an installation, information relating to its nature and its power, information relative to the volume subject to its influence, information on its position relative to the plan of the premises, notably the proximity of openings, and information on its relative position, notably its distance, in relation to the other climate apparatuses of the installation. The climate apparatus location information is advantageously used in the detection functions, such as the presence detection and the intrusion detection, and in the climate driving functions.

According to a mode of implementation independent of or complementing the preceding ones, of the system that is the subject of the invention, the latter comprises a step consisting in determining the dynamic behavior of the building in which said system is installed by self-learning over an observation and computation period. According to an example of implementation suited to convection or radiation heating, temperature rises are applied by controlling the heating power and compared to the trend of the temperature measured by the temperature probe of the climate apparatus. This information, possibly combined and refined with the geolocation information, is used to assess the response of the premises in which the climate apparatus is placed as a function of the driven climate parameter. Subsequently, this information makes it possible to better manage the standby periods in which the climate ambience is maintained in so-called standby conditions, corresponding to the apparatus being driven according to a reduced setting, and the so-called comfort periods, corresponding to conditions in which the room comprising the climate apparatus is occupied and in which the apparatus is driven according to a comfort setting, by anticipating the transitions between these periods as a function of the time constant of the premises concerned with respect to the driven climate parameter.

Thus, according to an example of application, this information relating to the time constant of the premises is used to implement a driving method comprising the steps consisting in:
determining the dynamic behavior of the building;
deducing therefrom, as a function of the characteristics of the climate apparatus, of its environment and of the climate conditions, a temperature rise time;
acquiring, from the memory means of the computer, the unoccupancy bands of the premises;
programming the periods of reduced setting as a function of the unoccupancy bands, of the temperature rise time and of the periods of operation imposed at reduced temperature;
computing the value of the reduced setting as a function of the conditions and of predictive information, obtained via the Internet;
detecting an unoccupancy of the premises above a determined threshold and reducing the reduced setting so as to limit the energy consumption in case of prolonged unoccupancy.

The predictive information is, according to an example of embodiment, drawn from data and algorithms collected and implemented by the user authority. Thus, the information making it possible to predict the periods of occupancy or unoccupancy comprises, for example, the meteorology or even information relating to road traffic. To this end, in order to define a probability of occupancy of the building and according to an example of embodiment, an application is installed on the cell phone of the user of the household, which application exchanges with the user authority the position of said cell phone. The distance between the user and his or her dwelling is addressed by the user authority to the computer of the climate system, or, more advantageously, a probability of arrival of the user in his or her dwelling at defined times, for example:
probability of arrival in at most 15 minutes: 0.2;
probability of arrival in at most 30 minutes: 0.5;
probability of arrival in at most 60 minutes: 0.95.

The temperature setting is adjusted as a function of this probability and of the time constant of the building, possibly in a way differentiated between each room of the dwelling as a function of the time.

By combining the principle of operation presented hereinabove with the climate apparatus location information, the system that is the subject of the invention is used to implement a so-called smart load-shedding profile making it possible to keep, at any moment, the consumed power below a defined threshold while ensuring optimal comfort for the user. Thus, the consumed power is known at any moment by a measurement performed on the meter according to methods known from the prior art. Via the local area network the computer receives, at any moment, information relating to rates of operation of the climate apparatuses of the installation as well as information on their environment, notably on the occupancy or the presence in the rooms in which said climate apparatuses are installed.

As a nonlimiting example, in a case where the target maximum consumption is exceeded, the choice of the apparatuses requiring load shedding is made by the computer according to the following order of priority and rules:
the temperature probe of the climate apparatus measures an ambient temperature above a threshold value, for example 21° C., said threshold value being able to be differentiated according to the room of the dwelling concerned;
the room is unoccupied and the climate apparatus is in economy mode, that is to say with a reduced setting;
the room is unoccupied and the climate apparatus is in comfort mode;
the room is occupied and the climate apparatus is in eco mode;
the room is occupied, and the climate apparatus is in comfort mode;
the climate apparatus is in non-freeze mode;
when two climate apparatuses have the same priority level, the apparatus with the lowest deviation between its setting temperature and the ambient temperature of the room is selected as priority;
if the shed climate apparatus is in a room where there are several apparatuses for which the power drawn is equal to or above that of the shed apparatus, the computer drives a rotation of the order of load shedding between the different apparatuses meeting the criterion in the room.

The above description and the examples of embodiment show that the invention meets the targets set, in particular it makes it possible to open up complex, interactive and open-ended operations to a climate system, including in the case of an existing installation and thus to optimize the operation of this system in order to save energy and to smooth the energy consumption. The climate system and the method that are the subjects of the invention make it possible to analyze the behaviors of the users and to anticipate the consumption conditions on a local scale, while retaining, at all times, the capacity for autonomous operation of the climate system.

1-15. (canceled)

16. A climate system comprising:
a climate apparatus;
a local area network comprising a computer linked to an Internet network access router;
the climate apparatus comprises a transmitter-receiver to transmit an information item relating to an operation of the climate apparatus over the local area network;
a personal terminal; and
wherein the transmitter-receiver of the climate apparatus is configured to communicate with the personal terminal and to relay signals from the personal terminal over the local area network.

17. The system as claimed in claim 16, wherein the local area network is a wireless network.

18. The system as claimed in claim 16, wherein the climate apparatus comprises a sensor to measure a parameter relating to an environment of the climate apparatus and the transmitter-receiver is configured to transmit an information item relating to a measurand estimated by the sensor.

19. The system as claimed in claim 16, wherein the climate apparatus comprises a presence detector and the transmitter-receiver is configured to transmit an information item relating to a state of the presence detector.

20. The system as claimed in claim 16, wherein the transmitter-receiver is configured to receive information from the local area network.

21. The system as claimed in claim 16, wherein the climate apparatus comprises a programmable logic circuit to drive the operation of the climate apparatus and to exchange information with the computer.

22. The system as claimed in claim 16, wherein the computer comprises a memory to store a climate apparatus location information item.

23. The system as claimed in claim 16, wherein the computer is incorporated in the climate apparatus.

24. The system as claimed in claim 23, further comprising a plurality of climate apparatuses, each climate apparatus comprising a housing to connect a driving cassette, one of said plurality of climate apparatuses comprising a driving cassette configured to perform functions of the computer and other apparatuses of said plurality of climate apparatuses comprising driving cassettes configured to perform functions of the transmitter-receiver.

25. A method for collecting and transmitting energy data implementing a climate system to a recipient user authority, comprising the steps of:
obtaining a datum on an operation of a climate apparatus of the climate system via a local area network of the climate system, the climate system comprises the climate apparatus, a personal terminal, the local area network comprising a computer linked to an Internet network access router, the climate apparatus comprises a transmitter-receiver to transmit an information item relating to the operation of the climate apparatus over the local area network,
storing the datum in a memory of the computer;
combining the stored datum to define an energy consumption profile;
transmitting the energy consumption profile over the local area network to the recipient user authority; and
receiving, from the recipient user authority, a request to trigger the combining and transmitting steps, the request comprising information on a data combination mode of the combining step used to define the energy consumption profile.

26. The method as claimed in claim 25, further comprising a step of modifying the operation of the climate apparatus as a function of the energy consumption profile.

27. The method as claimed in claim 25, wherein the obtaining step comprises steps of:
providing a plurality of modifications to the operation of the climate apparatus;
measuring a trend of a climate parameter modified in said plurality of modifications to the operation of the climate apparatus; and
computing a modification time constant of the climate parameter driven by the climate apparatus.

28. A method for implementing a climate system comprising a climate apparatus, a personal terminal and a local area network comprising a computer linked to an Internet network access router, the method comprising the steps of:
obtaining an identifier of the personal terminal of the climate system;
obtaining a user information on a user of the personal terminal;
detecting a proximity of the personal terminal with the climate apparatus of the system;
transmitting a detection information over the local area network by a transmitter-receiver of the climate apparatus, the transmitter-receiver being configured to communicate with the personal terminal and to relay signals from the personal terminal over the local area network; and
modifying an operation of the climate apparatus as a function of the user information.

29. The method as claimed in claim 28, further comprising steps of obtaining a geolocation of the personal terminal and geolocating the climate apparatus based on the geolocation of the personal terminal.

30. The method as claim in claim 21, wherein the climate apparatus comprises a sensor and is located in a premises; and further comprising steps of measuring a parameter relating to quality of air around the climate apparatus by the sensor, and transmitting an information item related to a measurand estimated by the sensor to monitor and adjust the quality of the air of the premises.

31. The system as claimed in claim 18, wherein the climate apparatus is located in a premises and the sensor is configured to detect an intrusion into the premises.
